(19) United States
(12) Patent Application Publication
(10) Pub. No.: US 2012/0102703 A1
(43) Pub. Date: May 3, 2012

(54) ROBOT SYSTEM AND METHOD FOR BOLT REMOVAL FROM SAG AND/OR BALL MILLS IN ORE CONCENTRATION PROCESSES

(76) Inventor: Hugo SALAMANCA, Santiago (CL)

(21) Appl. No.: 13/311,109

(22) Filed: Dec. 5, 2011

Related U.S. Application Data
(63) Continuation of application No. 11/598,096, filed on Nov. 13, 2006.
(60) Provisional application No. 60/734,976, filed on Nov. 10, 2005.

(51) Int. Cl. B23P 19/02

(52) U.S. Cl. 29/426.4; 901/31; 901/9

(57) ABSTRACT

The present invention is directed to a robotized method for removing discharge from furnaces used for smelting. The method includes punching and tapping exit passages, sampling different materials, and cleaning exit channels.

### CROSS-REFERENCE TO RELATED APPLICATIONS

This application is a continuation of U.S. patent application 11/598,096 filed Nov. 13, 2006 which claims the benefit of provisional patent application Ser. No. 60/734,976 filed 2005 Nov. 10 by the present inventor.

### FEDERAL SPONSORED RESEARCH

Not Applicable

### SEQUENCE LISTING OR PROGRAM

Not Applicable

### BACKGROUND

1. Field of Invention

This invention relates to the use of robotic technology in mining industry to improve the time spent for maintenance, specifically in the concentrator area.

2. Prior Art

Once the mineral is extracted from the mine, it must be subjected to a treatment to increase its purity. This metallurgical treatment is called concentration, which is carried out in a concentrating plant usually located near the production unit of the mine. This plant concentrates the minerals until their metal content reaches commercial values. The stages of this process are crushing and milling (the progressive reduction of particles until reaching sizes lower than one millimeter), followed by the flotation process using chemical reagents, where the valuable mineral (copper and molybdenum concentrates) is separated from the gangue (which is the worthless material, called tailing).

In the milling stage, special reactors called grinding mills are used in which the mineral comminution process is carried out (the process in which the particle is broken to a smaller size). This process is carried out by combining impact and abrasion under dry conditions or in a water suspension.

Such grinding machinery are provided with the so called liners which are generally used for the internal covering of the grinding machines. Due to the above, the inner wall of such machinery is also subjected to the impact and abrasion resulting from the material circulating inside, which leads to a constant wear of this surface. In order to absorb this permanent wear and not to damage the frame of the equipment, sacrifice parts called “liners” are installed, which are intended to improve the process through a geometry favouring the abrasion and impact among the particles the equipment. The liners should be replaced on a regular basis so as to avoid permanent damages to the equipment frame.

As part of the maintenance process SAG mills should be subjected to, the bolts which fasten the liners should be removed manually with hydraulic tools.

From the economic point of view, one of the major disadvantages which presents the current methods used for bolt removal is the long time maintenance takes, which generates a loss in the equipment productivity due to the fact production is reduced because of mill stoppage.

Another disadvantage of the current methods for bolt removal is safety, due to the fact the personnel should go inside the equipment to remove the bolts, which is usually a risky operation, mainly due to the fact some elements which are trapped between the liners fall down.

Due to the above, a robot system and method have been developed which allow to carry out an automated bolt removal process into the SAG mills, so as to diminish the time spent for maintenance.

### SUMMARY

A robotic system and a robotized method have been developed for slag and/or matte discharge proceedings from the smelting furnaces allowing to carry out necessary tasks in a automated way. These tasks are: Punching and tapping the exit passages, sampling the different materials and cleaning the exit channels

### DRAWINGS—FIGURES

In the drawings, closely related figures share the same numbers, with different alphabetic suffixes.

FIG. 1. View of the robotic manipulator removing a bolt in a SAG and/or ball mill.

FIG. 2. General view of a robot system for bolt removal in SAG and/or ball mills in ore comminution processes.

### REFERENCE NUMERALS

1. Robotic manipulator

2. Gripping mechanism

3. Fastening bolts

4. SAG or Ball mills

5. Bolts disposal

### DETAILED DESCRIPTION

This invention relates to a robotic method for bolt removal in grinding and/or ball mills, which includes use of anthropomorphous robotic arms of at least 5 degrees of freedom, which are installed at one or both sides of the mill.

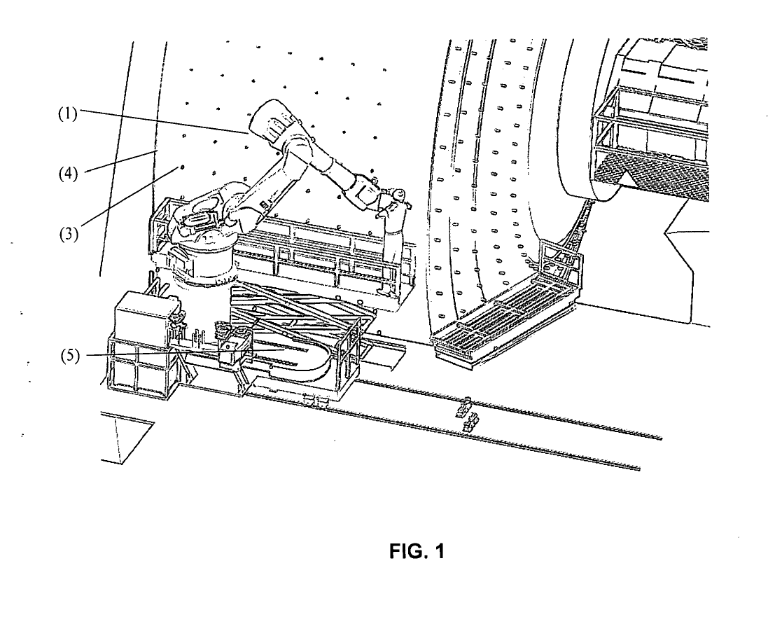

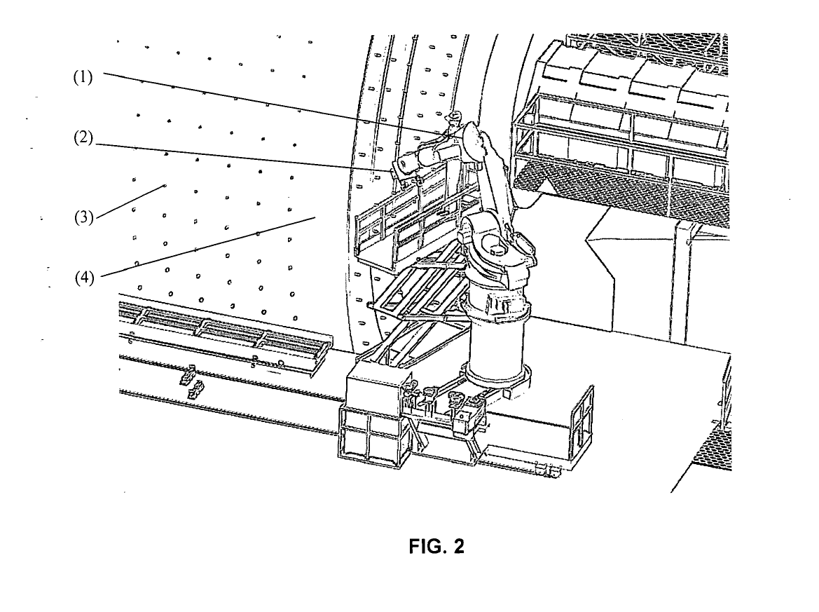

With reference to FIG. 1 and FIG. 2, the method includes use of a robot system comprised of robotic manipulator arm 1 of at least 5 degrees of freedom; a communication, acquisition and control system; and gripping mechanism 2 to allow, in a sequential and programmed way, the manipulator arm to take, manipulate, and release fastening bolt 3 from mill 4, and move said bolt to bolt disposal facility 5.

1-32. (canceled)

33. A robotic method for bolt removal from SAG and/or ball mills using a robotic manipulator comprising the steps of:
identifying a fastening bolt for removal,
gripping said fastening bolt,
extracting said fastening bolt, and
delivering said fastening bolt to a bolt disposal facility,
wherein said robotic manipulator includes an anthropomorphous robotic arm of at least 5 degrees of freedom and a gripping mechanism.

34. The method of claim 33, wherein said manipulator communicates directly or through a programmed logic controller interface with a remote control system.

35. The method of claim 33, wherein said manipulator includes the capability to obtain and interpret information from installed analogue or digital sensors.

36. The method of claim 33, wherein said manipulator includes the capability of generating analogue or digital signals to control analogue or digital input devices.

37. The method of claim 33, wherein said manipulator is mounted on a mobile support.

38. The method of claim 33, wherein said pneumatic gripping mechanism is pneumatic and includes at least 4 fingers.

39. The method of claim 33, wherein said manipulator includes an electrical system driven by three-stage induction motors with vectorial or scalar control.

40. The method of claim 33, wherein the system may operate automatically or semi-automatically.

41. The method of claim 33, wherein the method may further include the step of removal of liner bolts.
